(19) United States
(12) Patent Application Publication
(10) Pub. No.: US 2009/0169955 A1
(43) Pub. Date: Jul. 2, 2009

(54) MEMBRANE FOR FUEL CELLS, CONTAINING POLYMERS COMPRISING PHOSPHONIC ACID GROUPS AND/OR SULFONIC ACID GROUPS, MEMBRANE UNITS AND THE USE THEREOF IN FUEL CELLS

(75) Inventors: Oemer Uensal, Mainz (DE); Joerg Belack, Oberhausen (DE); Ivan Schopov, Sofia (BG); Vesselin Sinigersky, Sofia (BG); Hhristo Bratschkov, Sofia (BG); Stoicho Schenkov, Sofia (BG); Markus Klapper, Mainz (DE)

Correspondence Address: CONNOLLY BOVE LODGE & HUTZ, LLP, P O BOX 2207, WILMINGTON, DE, 19899, US

(73) Assignee: BASF FUEL CELL GMBH, FRANKFURT AM MAIN (DE)

(21) Appl. No.: 12/091,851

(22) PCT Filed: Oct. 28, 2006
(86) PCT No.: PCT/EP2006/010388

§ 371 Date: Jan. 22, 2009

(30) Foreign Application Priority Data
Oct. 29, 2005 (DE) 10 2005 051 887.7

(51) Int. Cl. H01M 8/10; B05D 5/12

(52) U.S. Cl. 429/33; 427/115

(57) ABSTRACT

Membrane for fuel cells, containing polymers comprising phosphonic acid and/or sulphonic acid groups, membrane electrode assemblies and the use thereof in fuel cells

The present invention relates to a membrane for fuel cells, containing polymers comprising phosphonic acid and/or sulphonic acid groups, characterized in that the polymer comprising phosphonic acid and/or sulphonic acid groups can be obtained by copolymerisation of monomers comprising phosphonic acid and/or sulphonic acid groups and hydrophobic monomers.

Membrane for fuel cells, containing polymers comprising phosphonic acid and/or sulphonic acid groups, membrane electrode assemblies and the use thereof in fuel cells

The present invention relates to a membrane for fuel cells, containing polymers comprising phosphonic acid and/or sulphonic acid groups, membrane electrode assemblies and the use thereof in fuel cells.

In today's polymer electrolyte membrane (PEM) fuel cells, sulphonic acid-modified polymers are primarily employed (e.g. Nafion from DuPont). Due to the conductivity mechanism of these membranes which depends on the water content, fuel cells provided therewith can only be operated at temperatures of up to 80 to 100° C. This membrane dries out at higher temperatures so that the resistance of the membrane increases sharply and the fuel cell can no longer provide electric energy.

Furthermore, polymer electrolyte membranes with complexes, for example, of alkaline polymers and strong acids have been developed. Thus, WO96/13872 and the corresponding U.S. Pat. No. 5,525,436 describe a process for the production of a proton-conducting polymer electrolyte membrane in which an alkaline polymer, such as polybenzimidazole, is treated with a strong acid, such as phosphoric acid, sulphuric acid etc.

In the alkaline polymer membranes known in the prior art, the mineral acid (mostly concentrated phosphoric acid) used—to achieve the required proton conductivity—is usually added following the forming of the polyazole film. In doing so, the polymer serves as a support for the electrolyte consisting of the highly concentrated phosphoric acid. In the process, the polymer membrane fulfils further essential functions, particularly, it has to exhibit a high mechanical stability and serve as a separator for the fuels.

An essential advantage of such a membrane doped with phosphoric acid is the fact that a fuel cell in which such a polymer electrolyte membrane is employed can be operated at temperatures above 10° C. without the humidification of the fuels otherwise necessary. This is due to the characteristic of the phosphoric acid to be able to transport the protons without additional water via the so-called Grotthus mechanism (K.-D. Kreuer, Chem. Mater. 1996, 8, 610-641).

Further advantages for the fuel cell system are achieved through the possibility of operation at temperatures above 100° C. On the one hand, the sensitivity of the Pt catalyst to gas impurities, in particular CO, is reduced substantially. CO is formed as a by-product in the reforming of hydrogen-rich gas from carbon-containing compounds, such as, e.g., natural gas, methanol or benzine, or also as an intermediate product in the direct oxidation of methanol. Typically, the CO content of the fuel has to be lower than 100 ppm at temperatures <100° C. However, at temperatures in the range of 150-2000, 10,000 ppm CO or more can also be tolerated (N. J. Bjerrum et. al., Journal of Applied Electrochemistry, 2001, 31, 773-779). This results in substantial simplifications of the upstream reforming process and therefore reductions of the cost of the entire fuel cell system.

A great advantage of fuel cells is the fact that, in the electrochemical reaction, the energy of the fuel is directly converted into electric energy and heat. In the process, water is formed at the cathode as a reaction product. Heat is also produced in the electrochemical reaction as a by-product. In applications in which only the power for the operation of electric motors is utilised, such as e.g. in automotive applications, or as a versatile replacement of battery systems, part of the heat generated in the reaction has to be dissipated to prevent overheating of the system. Additional energy-consuming devices which further reduce the total electric efficiency of the fuel cell system are then needed for cooling. In stationary applications, such as for the centralised or decentralised generation of electricity and heat, the heat can be used efficiently by existing technologies, such as, e.g., heat exchangers. In doing so, high temperatures are aimed for to increase the efficiency. If the operating temperature is higher than 100° C. and the temperature difference between the ambient temperature and the operating temperature is high, it will be possible to cool the fuel cell system more efficiently, for example using smaller cooling surfaces and dispensing with additional devices, in comparison to fuel cells which have to be operated at less than 100° C. due to the humidification of the membrane.

Apart from these advantages, however, such a fuel cell system also has disadvantages. For example, the durability of membranes doped with phosphoric acid is relatively limited. Here, the service life is considerably reduced in particular by operating the fuel cell below 100° C., for example at 80° C. In this connection, however, it should be noted that, when starting and shutting down the fuel cell, the cell has to be operated at these temperatures.

Furthermore, the production of membranes doped with phosphoric acid is relatively expensive as typically a polymer is initially formed which is subsequently cast to a film by means of a solvent. After drying the film, in a final step, it is doped with an acid. Therefore, the previously known polymer membranes have a high content of dimethylacetamide (DMAC) which cannot be removed completely by means of known drying methods.

Furthermore, the capability, for example the conductivity, of known membranes has to be improved further.

In addition, the durability of known high-temperature membranes with a high conductivity has to be improved further.

Furthermore, a very high amount of catalytically active substances is employed to obtain a membrane electrode assembly.

Therefore, the present invention has the object to provide a novel polymer electrolyte membrane which solves the objects set forth above. In particular, it should be possible to produce a membrane according to the invention inexpensive and in an easy way.

Furthermore, it was consequently an object of the present invention to provide polymer electrolyte membranes which exhibit a high capability, in particular a high conductivity, over a wide range of temperatures. In this connection, the conductivity should be achieved without an additional humidification, in particular at high temperatures. In this connection, the membrane should be suited to be processed further to a membrane electrode assembly which can provide particularly high power densities. Furthermore, a membrane electrode assembly obtainable through the membrane according to the invention should have a particularly high durability, in particular a long service life at high power densities.

Furthermore, it was consequently an object of the present invention to provide a membrane which can be transferred to a membrane electrode assembly which has a high capability, even at a very low content of catalytically active substances, such as for example platinum, ruthenium or palladium.

A further object of the invention was to provide a membrane which can be compressed to a membrane electrode assembly and the fuel cell can be operated with low stoichiometries, with little gas flow and/or with low excess pressure and high power density.

Furthermore, it should be possible to extend the operating temperature range of less than 20° C. to more than 120° C. without the service life of the fuel cell being reduced very heavily.

These objects are achieved by a membrane for fuel cells, containing polymers comprising phosphonic acid and/or sulphonic acid groups, having all the features of claim 1.

The object of the present invention is a membrane for fuel cells, containing polymers comprising phosphonic acid and/or sulphonic acid groups, characterized in that the polymer comprising phosphonic acid and/or sulphonic acid groups can be obtained by copolymerisation of monomers comprising phosphonic acid and/or sulphonic acid groups and hydrophobic monomers.

A membrane according to the invention exhibits a high conductivity over a wide range of temperatures which can also be achieved without an additional humidification.

Furthermore, a membrane according to the invention can be produced in an easy way and inexpensive. Thus, in particular, high amounts of expensive solvents, such as dimethylacetamide, or elaborate processes with polyphosphoric acid can be dispensed with.

Furthermore, these membranes exhibit a surprisingly long service life. Furthermore, a fuel cell which is provided with a membrane according to the invention can also be operated at low temperatures, for example at 80° C., without this reducing the service life of the fuel cell very heavily.

Furthermore, the membrane can be processed further to a membrane electrode assembly which can provide particularly high current intensities. A membrane electrode assembly thus obtained has a particularly high durability, in particular a long service life at high current intensities.

Furthermore, the membrane of the present invention can be transferred to a membrane electrode assembly which has a high capability, even at a very low content of catalytically active substances, such as for example platinum, ruthenium or palladium.

The polymer membrane according to the invention includes polymers comprising phosphonic acid and/or sulphonic acid groups which can be obtained by polymerisation of monomers comprising phosphonic acid groups and/or monomers comprising sulphonic acid groups.

The polymers comprising phosphonic acid and/or sulphonic acid groups can have repeating units which are derived from monomers comprising phosphonic acid groups, without the polymer having repeating units which are derived from monomers comprising sulphonic acid groups. Furthermore, the polymers comprising phosphonic acid and/or sulphonic acid groups can have repeating units which are derived from monomers comprising sulphonic acid groups, without the polymer having repeating units which are derived from monomers comprising phosphonic acid groups. Furthermore, the polymers comprising phosphonic acid and/or sulphonic acid groups can have repeating units which are derived from monomers comprising phosphonic acid groups, and repeating units which are derived from monomers comprising sulphonic acid groups. In this connection, polymers comprising phosphonic acid and/or sulphonic acid groups which have repeating units which are derived from monomers comprising phosphonic acid groups are preferred.

Monomers comprising phosphonic acid groups are known in professional circles. These are compounds having at least one carbon-carbon double bond and at least one phosphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the context of the present invention, the polymer containing phosphonic acid groups results from the polymerisation product which is obtained by polymerising the monomer containing phosphonic acid groups alone or with other monomers and/or crosslinkers.

The monomer comprising phosphonic acid groups may comprise one, two, three or more carbon-carbon double bonds. Furthermore, the monomer comprising phosphonic acid groups can contain one, two, three or more phosphonic acid groups.

Generally, the monomer comprising phosphonic acid groups contains 2 to 20, preferably 2 to 10, carbon atoms.

The monomer comprising phosphonic acid groups is preferably a compound of the formula

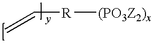

wherein
R represents a bond, a divalent C1015 alkylene group, a divalent C1-C15 alkylenoxy group, for example an ethylenoxy group, or a divalent C5-C20 aryl or heteroaryl group, wherein the above radicals may in turn be substituted by halogen, —OH, COOZ, —ON, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned radicals themselves can be substituted with halogen, —OH, —ON, and
x represents an integer 1, 2, 3, 4, 5, 6, 7, 8, 9 or 10
y represents an integer 1, 2, 3, 4, 5, 6, 7, 8, 9 or 10
   and/or of the formula

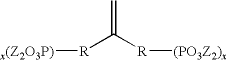

wherein
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
   and/or of the formula

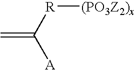

wherein
A represents a group of the formulae COOR², ON, CONR²₂, OR² and/or R², in which R² is hydrogen, a C1-C15 alkyl group, a C1-C15 alkoxy group, an ethylenoxy group or a C5-C20 aryl or heteroaryl group, wherein the above radicals themselves can be substituted by halogen, —OH, COOZ, —CN, NZ₂,
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned radicals themselves can be substituted with halogen, —OH, —CN, and
x is an integer 1, 2, 3, 4, 5, 6, 7, 8, 9 or 10.

The preferred monomers comprising phosphonic acid groups include, inter alia, alkenes which have phosphonic acid groups, such as ethenephosphonic acid, propenephosphonic acid, butenephosphonic acid; acrylic acid compounds and/or methacrylic acid compounds which have phosphonic acid groups, such as for example 2-phosphonomethylacrylic acid, 2-phosphonomethylmethacrylic acid, 2-phosphonomethylacrylic acid amide, 2-phosphonomethylmethacrylic acid amide and 2-acrylamido-2-methyl-1-propanephosphonic acid.

Commercially available vinylphosphonic acid (ethenephosphonic acid), such as it is available from the company Aldrich or Clariant GmbH, for example, is particularly preferably used. A preferred vinylphosphonic acid has a purity of more than 70%, in particular 90% and particularly preferably a purity of more than 97%.

The monomers comprising phosphonic acid groups can furthermore be employed in the form of derivatives, which subsequently can be converted to the acid, wherein the conversion to the acid can also take place in the polymerised state. These derivatives include in particular the salts, the esters, the amides and the halides of the monomers comprising phosphonic acid groups.

Monomers comprising sulphonic acid groups are known in professional circles. These are compounds having at least one carbon-carbon double bond and at least one sulphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the context of the present invention, the polymer comprising sulphonic acid groups results from the polymerisation product which is obtained by polymerising the monomer comprising sulphonic acid groups alone or with other monomers and/or crosslinkers.

The monomer comprising sulphonic acid groups may comprise one, two, three or more carbon-carbon double bonds. Furthermore, the monomer comprising sulphonic acid groups can contain one, two, three or more sulphonic acid groups.

Generally, the monomer comprising sulphonic acid groups contains 2 to 20, preferably 2 to 10, carbon atoms.

The monomers comprising sulphonic acid groups are preferably compounds of the formula

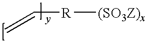

wherein
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10
y represents an integer 1, 2, 3, 4, 5, 6, 7, 8, 9 or 10 and/or of the formula

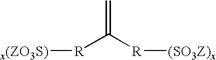

wherein
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C₁-C15 alkoxy group, an ethyleneoxy group or a C5-C20 aryl or heteroaryl group wherein the above-mentioned radicals themselves can be substituted with halogen, —OH, —CN, and
x represents an integer 1, 2, 3, 4, 5, 6, 7, 8, 9 or 10 and/or of the formula

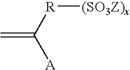

wherein
A represents a group of the formulae COOR², CN, CONR²₂, OR² and/or R², in which R² is hydrogen, a C1-C15 alkyl group, a C1-C15 alkoxy group, an ethylenoxy group or a C5-C20 aryl or heteroaryl group, wherein the above radicals themselves can be substituted by halogen, —OH, COOZ, —CN, NZ₂,
R represents a bond, a divalent C1-C15 alkylene group, a divalent C1-C15 alkyleneoxy group, for example ethyleneoxy group, or a divalent C5-C20 aryl or heteroaryl group wherein the above-mentioned radicals themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned radicals themselves can be substituted with halogen, —OH, —CN, and
x is an integer 1, 2, 3, 4, 5, 6, 7, 8, 9 or 10.

The preferred monomers comprising sulphonic acid groups include, inter alia, alkenes which have sulphonic acid groups, such as ethenesulphonic acid, propenesulphonic acid, butenesulphonic acid; acrylic acid compounds and/or methacrylic acid compounds which have sulphonic acid groups, such as for example 2-sulphonomethylacrylic acid, 2-sulphonomethylmethacrylic acid, 2-sulphonomethylacrylic acid amide, 2-sulphonomethylmethacrylic acid amide and 2-acrylamido-2-methyl-1-propanesulphonic acid.

Commercially available vinylsulphonic acid (ethenesulphonic acid), such as it is available from the company Aldrich or Clariant GmbH, for example, is particularly preferably used. A preferred vinylsulphonic acid has a purity of more than 70%, in particular 90% and particularly preferably a purity of more than 97%.

The monomers comprising sulphonic acid groups can furthermore be employed in the form of derivatives, which subsequently can be converted to the acid, wherein the conversion to the acid may also take place in the polymerised state. These derivatives include in particular the salts, esters, amides and halides of the monomers comprising sulphonic acid groups.

According to a particular aspect of the present invention, the weight ratio of monomers comprising sulphonic acid groups to monomers comprising phosphonic acid groups can be in the range of 100:1 to 1:100, preferably 10:1 to 1:10 and particularly preferably 2:1 to 1:2.

Hydrophobic monomers which can be used according to the invention are known per se in professional circles. Hydrophobic monomers define monomers which have a solubility in water at 25° C. of no more than 5 g/l, preferably no more than 1 g/l and which differ from the monomers comprising sulphonic acid groups and monomers comprising phosphonic acid groups set forth above. These monomers can be copolymerised with the monomers comprising sulphonic acid groups and/or monomers comprising phosphonic acid groups set forth above.

These include, inter alia,

1-alkenes, such as ethylene, 1,1-diphenylethylene, propene, 2-methylpropene, 1-butene, 2,3-dimethyl-1-butene, 3,3-dimethyl-1-butene, 2-methyl-1-butene, 3-methyl-1-butene, 2-butene, 2,3-dimethyl-2-butene, hexene-1, heptene-1; branched alkenes, such as for example vinylcyclohexane, 3,3-dimethyl-1-propene, 3-methyl-1-diisobutylene, 4-methylpentene-1;
acetylene monomers, such as acetylene, diphenylacetylene, phenylacetylene;
vinyl halides, such as vinyl fluoride, vinyl iodide, vinyl chlorides, such as 1-chloroethylene, 1,1-dichloroethylene, 1,2-dichloroethylene, trichloroethylene, tetrachloroethylene, vinyl bromide, such as tribromoethylene, 2-dibromoethylene, tetrabromoethylene, tetrafluoroethylene, tetraiodoethylene, 1-chloropropene, 2-chloropropene, 1,1-dichloropropene, 1,2-dichloropropene, 1,1,2-trichloropropene, 1,2,3-trichloropropene, 3,3,3-trichloropropene, 1-bromopropene, 2-bromopropene, 4-bromo-1-butene;
acrylic monomers, such as acrolein, 1-chloroacrolein, 2-methylacrylamide, acrylonitrile;
vinyl ether monomers, such as vinyl butyl ether, vinyl ether, vinyl fluoride, vinyl iodide, vinyl isoamyl ether, vinyl phenyl ether, vinyl ethyl ether, vinyl isobutyl ether, vinyl isopropyl ether, vinyl ethyl ether;
vinyl esters, such as vinyl acetate;
vinyl sulphide; methyl Isopropenyl ketone; 1,2-epoxypropene;
styrene monomers, such as styrene, substituted styrenes with one alkyl substituent in the side chain, such as, e.g., α-methylstyrene and α-ethylstyrene, substituted styrenes with one alkyl substituent on the ring, such as 1-methylstyrene, vinyl toluene and p-methylstyrene, halogenated styrenes, such as for example monochlorostyrenes, such as 1-chlorostyrene, 2-chlorostyrene, m-chlorostyrene, p-chlorostyrene, dichlorostyrenes, monobromostyrenes, such as 2-brbmostyrene, p-bromostyrene, tribromostyrenes, tetrabromostyrenes, m-fluorostyrene and o-fluorostyrene, m-methoxystyrene, o-methoxystyrene, p-methoxystyrene, 2-nitrostyrene;
heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;
vinyl and isoprenyl ethers;
maleic acid monomers, such as for example maleic acid, dihydroxymaleic acid, maleic anhydride, methylmaleic anhydride, dimethyl maleate, diethyl maleate, diphenyl maleate, maleimide and methylmaleimide;
fumaric acid monomers, such as fumaric acid, dimethylfumaric acid, diisobutyl fumarate, dimethyl fumarate, diethyl fumarate, diphenyl fumarate;
monomers comprising phosphonic acid groups, which can not be hydrolysed, such as 2-ethyloctyl vinyl phosphonic ester;
monomers comprising sulphonic acid groups, which can not be hydrolysed, such as 2-ethyloctyl vinyl sulphonic ester;
and (meth)acrylates. The term (meth)acrylates comprises methacrylates and acrylates as well as mixtures of both.

These monomers are widely known. These include, inter alia,

(meth)acrylates which are derived from saturated alcohols, such as, for example, methyl (meth)acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate;
(meth)acrylates which are derived from unsaturated alcohols, such as e.g. oleyl (meth)acrylate, 2-propinyl (meth)acrylate, allyl (meth)acrylate, vinyl (meth)acrylate;
aryl (meth)acrylates, such as benzyl (meth)acrylate or
phenyl (meth)acrylate, in which the aryl radicals can each be unsubstituted or substituted up to four times;
cycloalkyl (meth)acrylates, such as 3-vinylcyclohexyl (meth)acrylate, bornyl (meth)acrylate;
hydroxyalkyl (meth)acrylates, such as
3-hydroxypropyl (meth)acrylate,
3,4-dihydroxybutyl (meth)acrylate,
2-hydroxyethyl (meth)acrylate, 2-hydroxypropyl (meth)acrylate; glycol di(meth)acrylates, such as 1,4-butanediol di(meth)acrylate,
(meth)acrylates of ether alcohols, such as
tetrahydrofurfuryl (meth)acrylate, vinyl oxyethoxyethyl (meth)acrylate;
amides and nitrites of (meth)acrylic acid, such as
N-(3-dimethylaminopropyl) (meth)acrylamide,

### N-(diethylphosphono)(meth)acrylamide,

1-methacryloylamido-2-methyl-2-propanol;
sulphur-containing methacrylates, such as
ethylsulfinylethyl (meth)acrylate,
4-thiocyanatobutyl (meth)acrylate,
ethylsulfonylethyl (meth)acrylate,
thiocyanatomethyl (meth)acrylate,
methylsulfinylmethyl (meth)acrylate and
bis((meth)acryloyloxyethyl)sulphide.

The hydrophobic monomers preferably comprise precisely one copolymerisable carbon-carbon double bond or precisely one copolymerisable carbon-carbon triple bond.

The hydrophobic monomers are preferably stable to hydrolysis, Hydrolytic stability means that the monomers exhibit at most a saponification of 1%, preferably at most 0.5% in a hydrolysis treatment at 90° C. in the presence of concentrated HCl. From the monomers mentioned above, monomers which have no hydrolysable groups are particularly preferred.

To prepare the polymers comprising phosphonic acid and/or sulphonic acid groups, compositions which comprise at least 10% by weight, preferably at least 20% by weight and very particularly preferably at least 30% by weight, of hydrophobic monomers, based on the weight of the monomers, are preferably employed.

To prepare the polymers comprising phosphonic acid and/or sulphonic acid groups, compositions which comprise at least 10% by weight, preferably at least 20% by weight and very particularly preferably at least 30% by weight, of monomers comprising phosphonic acid groups, based on the weight of the monomers, are preferably employed.

To prepare the polymers comprising phosphonic acid and/or sulphonic acid groups, compositions which comprise at least 10% by weight, preferably at least 20% by weight and very particularly preferably at least 30% by weight, of monomers comprising sulphonic acid groups, based on the weight of the monomers, are preferably employed.

In another embodiment of the invention, monomers capable of cross-linking can be used in the production of the polymer membrane. The monomers capable of cross-linking are in particular compounds having at least 2 carbon-carbon double bonds. Preference is given to dienes, trienes, tetraenes, dimethylacrylates, trimethylacrylates, tetramethylacrylates, diacrylates, triacrylates, tetraacrylates.

Particular preference is given to dienes, trienes, tetraenes of the formula

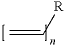

dimethylacrylates, trimethylacrylates, tetramethylacrylates of the formula

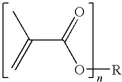

diacrylates, triacrylates, tetraacrylates of the formula

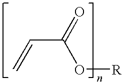

wherein
R represents a C1-C15 alkyl group, a C5-C20 aryl or heteroaryl group, NR′, —SO₂, PR′, Si(R′)₂, wherein the above-mentioned radicals themselves can be substituted,
R′ represents, independently of another, hydrogen, a C1-C15 alkyl group, a C1-C15 alkoxy group, a C5-C20 aryl or heteroaryl group, and
   n is at least 2.

The substituents of the above-mentioned radical R are preferably halogen, hydroxyl, carboxy, carboxyl, carboxylester, nitriles, amines, silyl, siloxane radicals.

Particularly preferred cross-linking agents are allyl acetonitrile, allyl bromide, 1-bromoallyl bromide, allyl chloride, 1-chloroallyl chloride, allyl ether, allyl ethyl ether, allyl iodide, allyl methyl ether, allyl phenyl ether, 4-chloroallyl phenyl ether, 2,4,6-tribromoallyl phenyl ether, allyl propyl ether, allyl 2-tolyl ether, allyl 3-tolyl ether, allyl 4-tolyl ether, allyl acetate, allyl acetic acid, 3-chloroallyl alcohol, allyl cyamide, allyl fluoride, allyl isocyanide, allyl formate,

1,2-butadiene, 1,3-butadiene, 2-bromo-1,3-butadiene, 3-methyl-1,3-butadiene, hexachloro-1,3-butadiene, isoprene, chloro-1,2-butadiene, 2-chloro-1,3-butadiene, allyl methacrylate, ethylene glycol dimethacrylate, diethylene glycol dimethacrylate, triethylene glycol dimethacrylate, tetraethylene glycol dimethacrylate and polyethylene glycol dimethacrylate, 1,3-butanediol dimethacrylate, glycerol dimethacrylate, diurethane dimethacrylate, trimethylpropane trimethacrylate, epoxy acrylates, for example ebacryl, N′,N-methylenebisacrylamide, carbinol, butadiene, isoprene, chloroprene, divinylbenzene and/or bisphenol A dimethylacrylate. These compounds are commercially available from Sartomer Company Exton, Pa. under the designations CN-120, CN104 and CN-980, for example. The use of cross-linking agents is optional, wherein these compounds can typically be employed in the range of 0.05 and 30% by weight, preferably 0.1 to 20% by weight, particularly preferably 1 to 10% by weight, based on the weight of the monomers comprising phosphonic acid groups.

The polymerisation of the monomer mentioned above is known per se, this preferably taking place via the free-radical route. The formation of radicals can take place thermally, photochemically, chemically and/or electrochemically.

Suitable radical formers are, amongst others, azo compounds, peroxy compounds, persulphate compounds or azoamidines. Non-limiting examples are dibenzoyl peroxide, dicumene peroxide, cumene hydroperoxide, diisopropyl peroxydicarbonate, bis(4-t-butylcyclohexyl) peroxydicarbonate, dipotassium persulphate, ammonium peroxydisulphate, 2,2′-azobis(2-methylpropionitrile) (AIBN), 2,2′-azobis(isobutyric acid amidine)hydrochloride, benzopinacol, dibenzyl derivatives, methyl ethylene ketone peroxide, 1,1-azobiscyclohexanecarbonitrile, methyl ethyl ketone peroxide, acetyl acetone peroxide, dilauryl peroxide, didecanoyl peroxide, tert-butylper-2-ethyl hexanoate, ketone peroxide, methyl isobutyl ketone peroxide, cyclohexanone peroxide, dibenzoyl peroxide, tert-butylperoxybenzoate, tert-butylperoxyisopropylcarbonate, 2,5-bis(2-ethylhexanoylperoxy)-2,5-dimethylhexane, tert-butylperoxy-2-ethylhexanoate, tert.-butylperoxy-3,5,5-trimethylhexanoate, tert-butylperoxyisobutyrate, tert-butylperoxyacetate, dicumene peroxide, 1,1-bis(tert-butylperoxy)cyclohexane, 1,1-bis(tert-butylperoxy)-3,3,5-trimethylcyclohexane, cumyl hydroperoxide, tert-butylhydroperoxide, bis(4-tert-butylcyclohexyl) peroxydicarbonate, and the radical formers available from DuPont under the name ®Vazo, for example ®Vazo V50 and ®Vazo WS.

Furthermore, it is also possible to employ radical formers which form radicals with irradiation. The preferred compounds include, amongst others, α,α-diethoxyacetophenone (DEAP, Upjon Corp), n-butyl benzoin ether (®Trigonal-14, AKZO) and 2,2-dimethoxy-2-phenylacetophenone (®Igacure 651) and 1-benzoyl cyclohexanol (®Igacure 184), bis-(2,4,6-trimethylbenzoyl)phenylphosphine oxide (®Irgacure 819) and 1-[4-(2-hydroxyethoxy)phenyl]-2-hydroxy-2-phenylpropan-1-one (®Irgacure 2959) each of which is commercially available from the company Ciba Geigy Corp.

Typically, between 0.0001 and 5% by weight, in particular 0.01 to 3% by weight (based on the weight of the hydrophobic monomers and the monomers comprising phosphonic acid groups and/or sulphonic acid groups) of radical formers are added. The amount of radical former can be varied according to the degree of polymerisation desired.

The polymer comprising phosphonic acid and/or sulphonic acid groups obtained by the polymerisation preferably has a solubility in water at 90° C. of no more than 10 g/l, particularly preferably no more than 5 g/l and very particularly preferably no more than 0.5 g/l. In this connection, the water solubility can be determined according to the so-called shake-flask method.

According to a particular aspect, the weight ratio of the monomers comprising phosphonic acid and/or sulphonic acid groups to the hydrophobic monomers can preferably be in the range of 10:1 to 1:10, particularly preferably 5:1 to 1:5. The higher the proportion of hydrophobic monomers, the lower is the solubility of the polymer in water, wherein, however, the conductivity is being decreased. Because of the low water solubility of the polymer, in many cases, the use of further polymers to stabilise the membrane can be reduced without the durability or the service life of the membrane being lowered.

The polymer comprising phosphonic acid groups and/or sulphonic acid groups can preferably have a weight average of the molecular weight of at least 3000 g/mol, particularly preferably at least 10,000 g/mol and very particularly preferably at least 100,000 g/mol.

The polymer comprising phosphonic acid and/or sulphonic acid groups can be a random copolymer, a block copolymer or a graft copolymer.

Polymer membranes according to the invention can be obtained by processes generally known. To this end, the polymer can first be obtained by known processes, for example a solvent or a bulk polymerisation. The polymer can be transferred to a membrane in a subsequent step, for example by extrusion.

Furthermore, these polymer membranes can be obtained, amongst other possibilities, by a process comprising the steps of
A) preparation of a composition containing hydrophobic monomers and monomers comprising phosphonic acid groups and/or sulphonic acid groups,
B) applying a layer using the composition in accordance with step A) to a support,
C) polymerisation of the monomers present in the flat structure obtainable in accordance with step B).

The membrane can preferably contain at least 50% by weight, particularly preferably at least 80% by weight and very particularly preferably at least 90% by weight, of at least one polymer comprising phosphonic acid and/or sulphonic acid groups which can be obtained by copolymerisation of monomers comprising phosphonic acid and/or sulphonic acid groups and hydrophobic monomers.

The composition produced in step A) preferably comprises at least 20% by weight, in particular at least 30% by weight and particularly preferably at least 50% by weight, based on the total weight of the composition, of monomers comprising phosphonic acid groups.

The composition produced in step A) can additionally contain further organic and/or inorganic solvents. The organic solvents include in particular polar aprotic solvents, such as dimethyl sulphoxide (DMSO), esters, such as ethyl acetate, and polar protic solvents, such as alcohols, such as ethanol, propanol, isopropanol and/or butanol. The inorganic solvents include in particular water, phosphoric acid and polyphosphoric acid.

These can affect the processibility in a positive way. In particular, the solubility of polymers which are formed, for example, in step B) can be improved by the addition of the organic solvent. The concentration of monomers comprising phosphonic acid groups in such solutions is generally at least 5% by weight, preferably at least 10% by weight, particularly preferably between 10 and 97% by weight.

If desired, cross-linking monomers can be added to the composition, for example in step A). Additionally, the monomers capable of cross-linking can also be applied to the flat structure in accordance with step C).

Additionally to the polymers comprising phosphonic acid groups, the polymer membranes of the present invention can comprise further polymers (B) which cannot be obtained by polymerisation of monomers comprising phosphonic acid groups.

Surprisingly, by using these polymers (B), the stability of the membrane can be increased. However, using these polymers (B) is associated with expenditure. Furthermore, the conductivity of the membrane, based on the weight, can decrease. To this end, a further polymer (B) can be added to the composition created in step A), for example. This polymer (B) may be present, amongst others, in dissolved, dispersed or suspended form.

The preferred polymers (B) include, amongst others, polyolefines, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinyl amine, poly(N-vinyl acetamide), polyvinyl imidazole, polyvinyl carbazole, polyvinyl pyrrolidone, polyvinyl pyridine, polyvinyl chloride, polyvinylidene chloride, polytetrafluoroethylene, polyvinyl difluoride, polyhexafluoropropylene, polyethylenetetrafluoroethylene, copolymers of PTFE with hexafluoropropylene, with perfluoropropylvinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornenes;

polymers having C—O bonds in the backbone, for example
polyacetal, polyoxymethylene, polyether, polypropylene oxide, polyepichlorohydri n, polytetrahydrofuran, polyphenylene oxide, polyether ketone, polyether ether ketone, polyether ketone ketone, polyether ether ketone, ketone, polyether ketone ether ketone ketone, polyester, in particular polyhydroxyacetic acid,
polyethyleneterephthalate, polybutyleneterephthalate, polyhydroxybenzoate, polyhydroxypropionic acid, polypropionic acid, polypivalolacton, polycaprolacton, furan resins, phenol aryl resins, polymalonic acid, polycarbonate;
polymeric C—S bonds in the backbone, for example polysulphide ether, polyphenylenesulphide, polyethersulphone, polysulphone, polyetherethersulphone, polyarylethersulphone, polyphenylenesulphone, polyphenylenesulphidesulphone, poly(phenylsulphide)-1,4-phenylene;
polymers containing C—N bonds in the backbone, for example
polyimines, polyisocyanides, polyetherimine, polyetherimides, poly(trifluoromethyl)bis(phthalimide)phenyl, polyaniline, polyaramides, polyamides, polyhydrazides, polyurethanes, polyimides, polyazoles, polyazole ether ketone, polyureas, polyazines;
liquid crystalline polymers, in particular Vectra, as well as
inorganic polymers, such as polysilanes, polycarbosilanes, polysiloxanes, polysilicic acid, polysilicates, silicones, polyphosphazenes and polythiazyl.

These polymers can be used individually or as a mixture of two, three or more polymers.

Particular preference is given to polymers containing at least one nitrogen atom, oxygen atom and/or sulphur atom in a repeating unit. Particularly preferred are polymers containing at least one aromatic ring with at least one nitrogen, oxygen and/or sulphur heteroatom per repeating unit. From this group, polymers based on polyazoles are particularly preferred. These alkaline polyazole polymers contain at least one aromatic ring with at least one nitrogen heteroatom per repeating unit.

The aromatic ring is preferably a five- to six-membered ring with one to three nitrogen atoms which can be fused to another ring, in particular another aromatic ring.

In this connection, polyazoles are particularly preferred. Polymers based on is polyazole generally contain recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

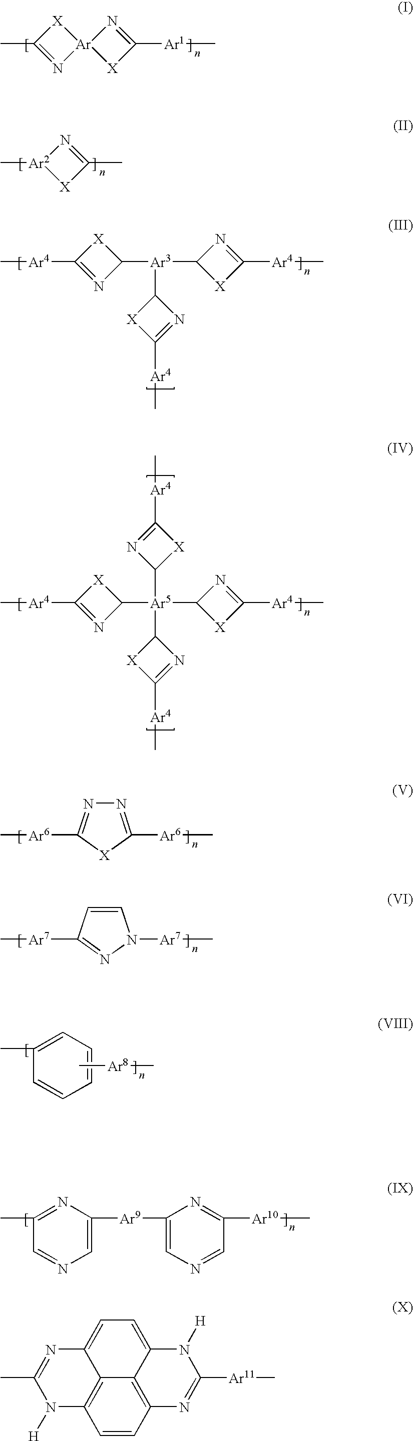

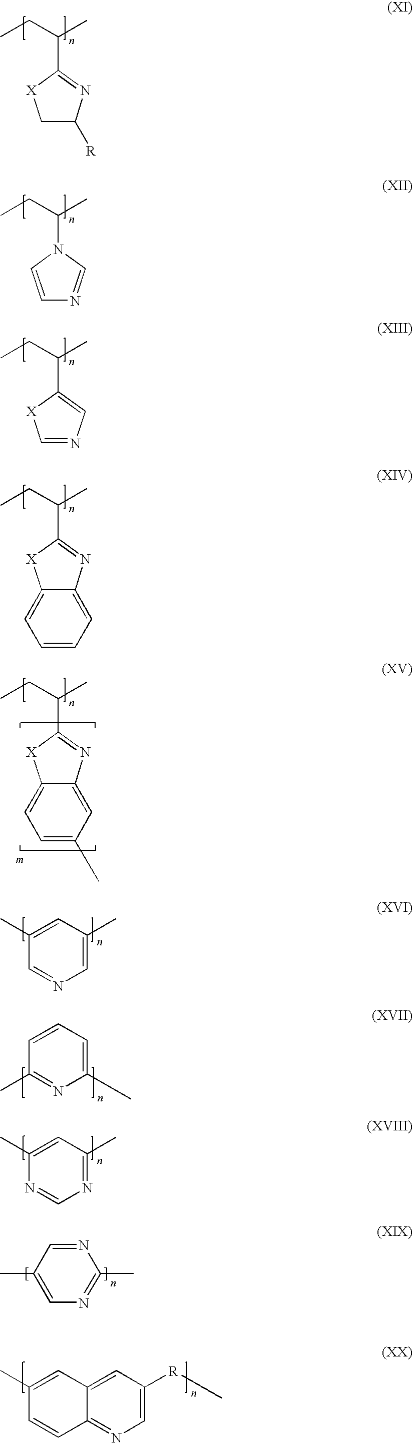

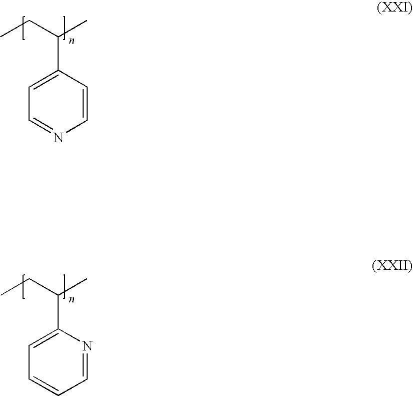

wherein
Ar are identical or different and represent a tetravalent aromatic or heteroaromatic group which can be mononuclear or polynuclear,
Ar¹ are identical or different and represent a divalent aromatic or heteroaromatic group which can be mononuclear or polynuclear,
Ar² are identical or different and represent a divalent or trivalent aromatic or heteroaromatic group which can be mononuclear or polynuclear,
Ar³ are identical or different and represent a trivalent aromatic or heteroaromatic group which can be mononuclear or polynuclear,
Ar⁴ are the same or different and are each a trivalent aromatic or heteroaromatic group which may be mononuclear or polynuclear,
Ar⁵ are the same or different and are each a tetravalent aromatic or heteroaromatic group which may be mononuclear or polynuclear,
Ar⁶ are the same or different and are each a divalent aromatic or heteroaromatic group which may be mononuclear or polynuclear,
Ar⁷ are the same or different and are each a divalent aromatic or heteroaromatic group which may be mononuclear or polynuclear,
Ar⁸ are the same or different and are each a trivalent aromatic or heteroaromatic group which may be mononuclear or polynuclear,
Ar⁹ are the same or different and are each a divalent or trivalent or tetravalent aromatic or heteroaromatic group which may be mononuclear or polynuclear,
Ar¹⁰ are the same or different and are each a divalent or trivalent aromatic or heteroaromatic group which may be mononuclear or polynuclear,
Ar¹¹ are the same or different and are each a divalent aromatic or heteroaromatic group which may be mononuclear or polynuclear,
X are the same or different and are each oxygen, sulphur or an amino group which bears a hydrogen atom, a group having 1-20 carbon atoms, preferably a branched or unbranched alkyl or alkoxy group, or an aryl group as further radical,
R represent, identical or different, hydrogen, an alkyl group and an aromatic group, represents, identical or different, hydrogen, an alkyl group and an aromatic group, with the proviso that R in the formula XX is a divalent group, and
n, m are each an integer greater than or equal to 10, preferably greater or equal to 100.

Preferred aromatic or heteroaromatic groups are derived from benzene, naphthalene, biphenyl, diphenyl ether, diphenylmethane, diphenyldimethylmethane, bisphenone, diphenylsulphone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸₇ Ar⁹, Ar¹⁰, Ar¹¹ can be ortho-, meta- and para-phenylene. Particularly preferred groups are derived from benzene and biphenylene, which may also be substituted.

Preferred alkyl groups are short-chain alkyl groups having 1 to 4 carbon atoms, e.g., methyl, ethyl, n- or i-propyl and t-butyl groups.

Preferred aromatic groups are phenyl or naphthyl groups. The alkyl groups and the aromatic groups can be substituted.

Preferred substituents are halogen atoms, such as, e.g., fluorine, amino groups, hydroxy groups or short-chain alkyl groups, such as, e.g., methyl or ethyl groups. Polyazoles having recurring units of the formula (I) are preferred wherein the radicals X within one recurring unit are identical.

The polyazoles can in principle also have different recurring units wherein their radicals X are different, for example. It is preferable, however, that a recurring unit has only identical radicals X.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In another embodiment of the present invention, the polymer containing recurring azole units is a copolymer or a blend which contains at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer containing recurring azole units is a polyazole, which only contains units of the formulae (I) and/or (II).

The number of recurring azole units in the polymer is preferably an integer greater than or equal to 10. Particularly preferred polymers contain at least 100 recurring azole units.

Within the context of the present invention, polymers containing recurring benzimidazole units are preferred. Some examples of the most appropriate polymers containing recurring benzimidazole units are represented by the following formulae:

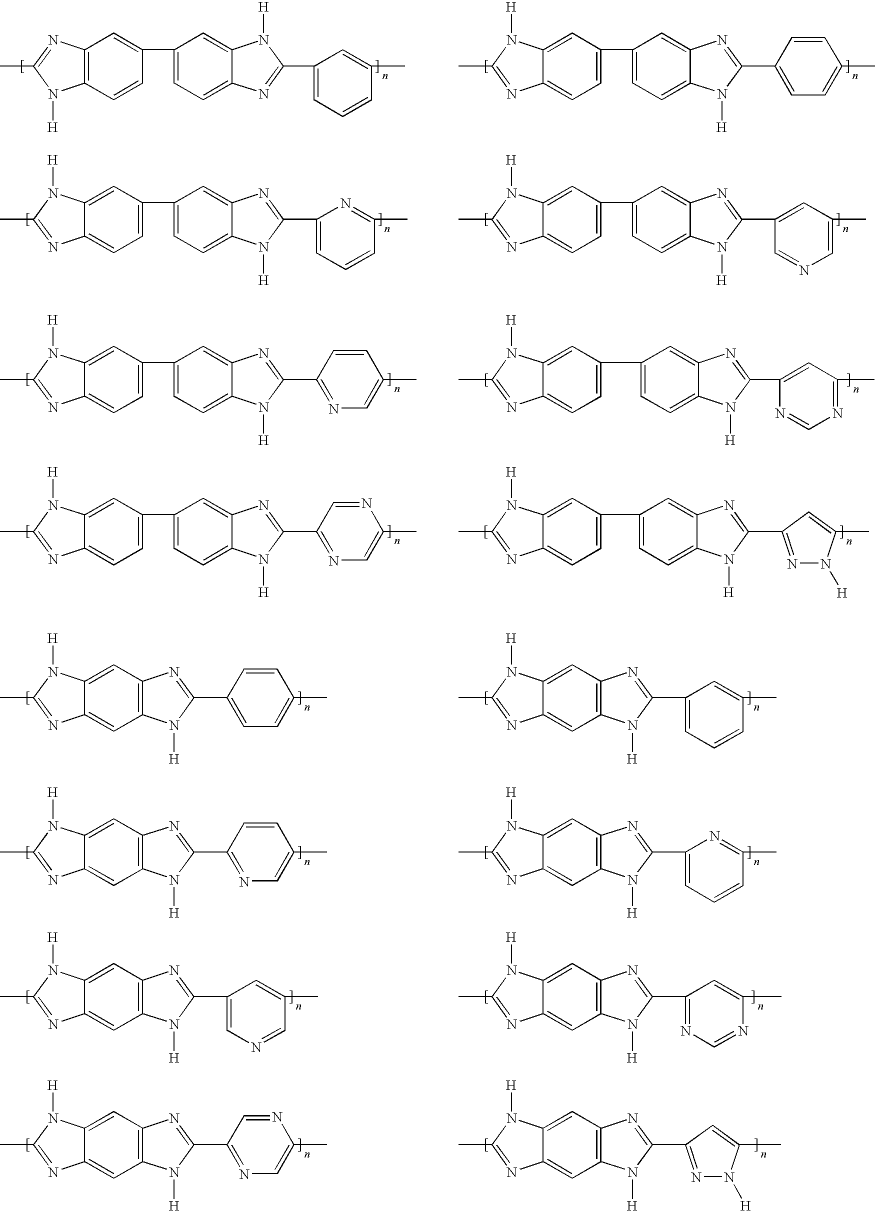

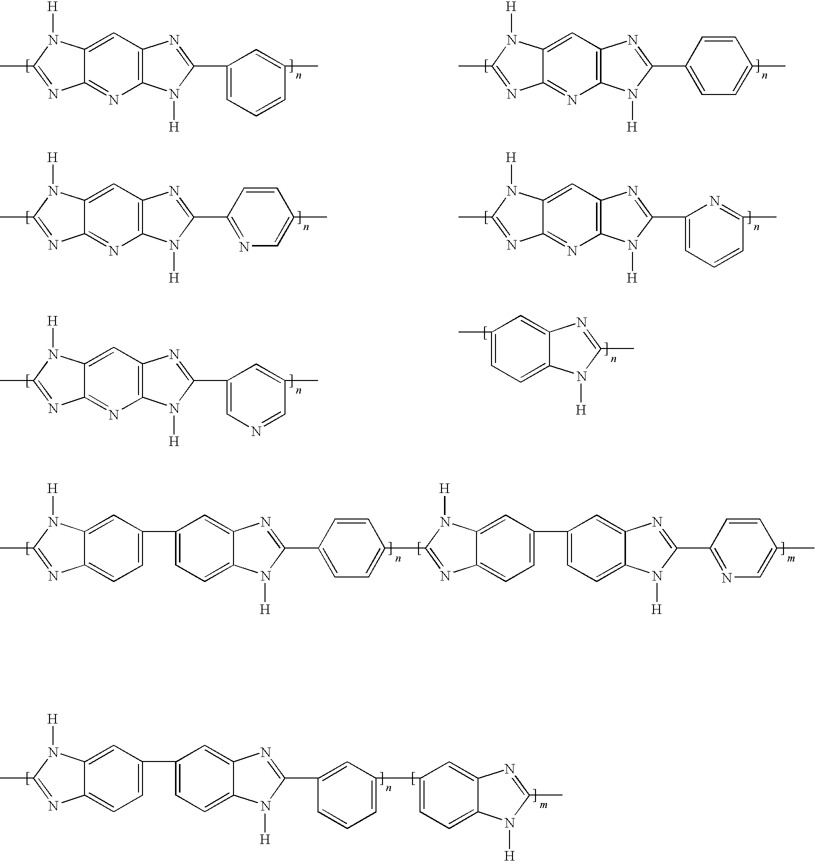

wherein n and m are each an integer greater than or equal to 10, preferably greater than or equal to 100.

Further preferred polyazole polymers are polyimidazoles, polybenzimidazole ether ketone, polybenzothiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

Preferred polyazoles are characterized by a high molecular weight. This applies in particular to the polybenzimidazoles. Measured as the intrinsic viscosity, this is preferably at least 0.2 dl/g, preferably 0.7 to 10 dl/g, in particular 0.8 to 5 dl/g.

Celazole from the company Gelanese is particularly preferred. The properties of polymer film and polymer membrane can be improved by screening the starting polymer, as described in German patent application No. 10129458.1.

Furthermore, polymers with aromatic sulphonic acid groups can be used as polymer (B). Aromatic sulphonic acid groups are groups in which the sulphonic acid groups (—SO₃H) are bound covalently to an aromatic or heteroaromatic group. The aromatic group can be part of the backbone of the polymer or part of a side group wherein polymers having aromatic groups in the backbone are preferred. In many cases, the sulphonic acid groups can also be used in the form of their salts. Furthermore, derivatives, for example esters, in particular methyl or ethyl esters, or halides of the sulphonic acids can be used, which are converted to the sulphonic acid during operation of the membrane.

The polymers modified with sulphonic acid groups preferably have a content of sulphonic acid groups in the range of 0.5 to 3 meq/g, preferably 0.5 to 2.5. This value is determined through the so-called ion exchange capacity (IEC).

To measure the IEC, the sulphonic acid groups are converted to the free acid. To this end, the polymer is treated in a known way with acid, removing excess acid by washing. Thus, the sulphonated polymer is initially treated for 2 hours in boiling water. Subsequently, excess water is dabbed off and the sample is dried at 160° C. in a vacuum drying cabinet at p<1 mbar for 15 hours. Then, the dry weight of the membrane is determined. The polymer thus dried is then dissolved in DMSO at 80° C. for 1 h. Subsequently, the solution is titrated with 0.1 M NaOH. The ion exchange capacity (IEC) is then calculated from the consumption of acid up to the equivalent point and the dry weight.

Polymers with sulphonic acid groups covalently bound to aromatic groups are known in professional circles. Polymers with aromatic sulphonic acid groups can, for example, be produced by sulphonation of polymers. Processes for the sulphonation of polymers are described in F. Kucera et al., Polymer Engineering and Science 1988, Vol. 38, No. 5, 783-792. In this connection, the sulphonation conditions can be chosen such that a low degree of sulphonation develops (DE-A-19959289).

With regard to polymers having aromatic sulphonic acid groups whose aromatic radicals are part of the side group, particular reference shall be made to polystyrene derivatives. The document U.S. Pat. No. 6,110,616 for instance describes copolymers of butadiene and styrene and their subsequent sulphonation for use in fuel cells.

Furthermore, such polymers can also be obtained by polyreactions of monomers, which comprise acid groups. Thus, perfluorinated polymers as described in U.S. Pat. No. 5,422,411 can be produced by copolymerisation of trifluorostyrene and sulphonyl-modified trifluorostyrene.

According to a particular aspect of the present invention, thermoplastics stable at high temperatures, which include sulphonic acid groups bound to aromatic groups are employed. In general, such polymers have aromatic groups in the backbone. Thus, sulphonated polyether ketones (DE-A-4219077, WO96/01177), sulphonated polysulphones (J. Membr. Sci. 83 (1993), p. 211) or sulphonated polyphenylenesulphide (DE-A-19527435) are preferred.

The polymers set forth above which have sulphonic acid groups bound to aromatic groups can be used individually or as a mixture wherein mixtures having polymers with aromatic groups in the backbone are particularly preferred.

The preferred polymers include polysulphones, in particular polysulphone having aromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133.

According to a particular aspect of the present invention, the weight ratio of polymer with sulphonic acid groups covalently bound to aromatic groups to monomers comprising phosphonic acid groups can be in the range from 0.1 to 50, preferably from 0.2 to 20, particularly preferably from 1 to 10.

According to a particular aspect of the present invention, preferred proton-conducting polymer membranes can be obtained by a process comprising the steps of
I) swelling a polymer film with a liquid containing hydrophobic monomers and monomers comprising phosphonic acid groups and/or sulphonic acid groups, and
II) polymerisation of at least part of the monomers comprising phosphonic acid groups, which were introduced into the polymer film in step I).

Swelling is understood to mean an increase in weight of the film by at least 3% by weight. Preferably, the swelling is at least 5%, particularly preferably at least 10%.

The determination of swelling Q is determined gravimetrically from the mass of the film before swelling, m₀ and the mass of the film after polymerisation in accordance with step B), m₂.

Q=(m₂−m₀)/m₀×100

The swelling preferably takes place at a temperature of more than 0° C., in particular between room temperature (20° C.) and 180° C., in a liquid which preferably contains at least 5% by weight of monomers comprising phosphonic acid groups. Furthermore, the swelling can also be performed at increased pressure. In this connection, the limitations arise from economic considerations and technical possibilities.

The polymer film used for swelling generally has a thickness in the range from 5 to 1000 μm, preferably 10 to 500 μm and particularly preferably 20 to 300 μm. The production of such films made of polymers is generally known, a part of these being commercially available.

The liquid containing hydrophobic monomers and monomers comprising phosphonic acid groups and/or sulphonic acid groups may be a solution, wherein the liquid may also contain suspended and/or dispersed constituents. The viscosity of the liquid containing monomers comprising phosphonic acid groups can be within wide ranges wherein an addition of solvents or an increase of the temperature can be executed to adjust the viscosity. Preferably, the dynamic viscosity is in the range of 0.1 to 10000 mPa*s, in particular 0.2 to 2000 mPa*s, wherein these values can be measured in accordance with DIN 53015, for example.

The composition produced in step A) or the liquid used in step I) can additionally contain further organic and/or inorganic solvents. The organic solvents include in particular polar aprotic solvents, such as dimethyl sulphoxide (DMSO), esters, such as ethyl acetate, and polar protic solvents, such as alcohols, such as ethanol, propanol, Isopropanol and/or butanol. The inorganic solvents include in particular water, phosphoric acid and polyphosphoric acid. These can affect the processibility in a positive way. For example, the rheology of the solution can be improved such that this can be more easily extruded or applied with a doctor blade.

To further improve the properties in terms of application technology, fillers, in particular proton-conducting fillers, and additional acids can additionally be added to the membrane. Such substances preferably have an intrinsic conductivity at 100° C. of at least 10⁻⁶ S/cm, in particular 10⁻⁵ S/cm. The addition can be performed in step A) and/or step B) or step I), for example. Furthermore, these additives can also be added after the polymerisation in accordance with step C) or step II), if they are in the form of a liquid.

Non-limiting examples of proton-conducting fillers are
sulphates, such as CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,
phosphates, such as Zr3(PO4)4, Zr(HPO4)2, HZr2(PO4)3, UO2PO4.3H2O, HBUO2PO4, Ce(HPO4)2, Ti(HPO4)2, KH2PO4, NaH2PO4, LiH2PO4, NH4H2PO4, CsH2PO4, CaHPO4, MgHPO4, HSbP2O8, HSb3P2O14, H5Sb5P2O20,
polyacids such as H₃PW₁₂O₄₀.nH₂O (n=21-29), H₃SiW₁₂O₄₀.nH₂O (n=21-29), H×WO₃, HSbWO₆, H₃PMo₁₂O₄₀, H₂Sb₄O₁₁, HTaWO₆, HNbO₃, HTiNbO₅, HTiTaO₅, HSbTeO₆, H₅Ti₄O₉, HSbO₃, H₂MoO₄
selenites and arsenites such as (NH₄)₃H(SeO₄)₂, UO₂AsO₄, (NH₄)₃H(SeO₄)₂, KH₂AsO₄, Cs₃H(SeO₄)₂, Rb₃H(SeO₄)₂,
phosphides ZrP, TiP, HfP
oxides, such as Al₂O₃, Sb₂O₅, ThO₂, SnO₂₁ ZrO₂, MoO₃
silicates, such as zeolites, zeolites(NH₄+), phyllosilicates, tectosilicates, H-natrolites, H-mordenites, NH₄-analcines, NHR₄-sodalites, NH₄-gallates, H-montmorillonites
acids, such as HClO4, SbF5
fillers, such as carbides, in particular SiC, Si₃N₄, fibres, in particular glass fibres, glass powders and/or polymer fibres, preferably based on polyazoles.

These additives can be included in the proton-conducting polymer membrane in usual amounts, however, the positive properties of the membrane, such as great conductivity, long service life and high mechanical stability, should not be affected too much by the addition of too large amounts of additives. Generally, the membrane comprises not more than 80% by weight, preferably not more than 50% by weight and particularly preferably not more than 20% by weight, of additives after the polymerisation in accordance with step C) or step II).

As a further component, this membrane can also contain perfluorinated sulphonic acid additives (in particular 0.1-20% by weight, preferably 0.2-15% by weight, very preferably 0.2-10% by weight). These additives result in an improvement in performance, to an increase in oxygen solubility and oxygen diffusion in the vicinity of the cathode and to a reduction in adsorption of the electrolyte on the catalyst surface. (Electrolyte additives for phosphoric acid fuel cells. Gang, Xiao; Hjuler, H. A.; Olsen, C.; Berg, R. W.; Bjerrum, N.J. Chem. Dep. A, Tech. Univ. Denmark, Lyngby, Den. J. Electrochem. Soc. (1993), 140(4), 896-902, and Perfluorosulfonimide as an additive in phosphoric acid fuel cell. Razaq, M.; Razaq, A.; Yeager, E.; DesMarteau, Darryl D.; Singh, S. Case Cent. Electrochem. Sci., Case West. Reserve Univ., Cleveland, Ohio, USA. J. Electrochem. Soc. (1989), 136(2), 385-90.) Non-limiting examples of perfluorinated sulphonic acid additives are: trifluoromethanesulphonic acid, potassium trifluoromethanesulphonate, sodium trifluorornethanesulphonate, lithium trifluoromethanesulphonate, ammonium trifluoromethanesulphonate, potassium perfluorohexanesulphonate, sodium perfluorohexanesulphonate, lithium perfluorohexanesulphonate, ammonium perfluorohexanesulphonate, perfluorohexanesulphonic acid, potassium nonafluorobutanesulphonate, sodium nonafluorobutanesulphonate, lithium nonafluorobutanesulphonate, ammonium nonafluorobutanesulphonate, caesium nonafluorobutanesulphonate, triethylammonium perfluorohexanesulphonate and perfluorosulphoimides.

The formation of the flat structure in accordance with step B) is performed by means of measures known per se (pouring, spraying, application with a doctor blade, extrusion) which are known from the prior art of polymer film production. Every support that is considered as inert under the conditions is suitable as a support. These supports include in particular films made of polyethylene terephthalate (PET), polytetrafluoroethylene (PTFE), polyhexafluoropropylene, copolymers of PTFE with hexafluoropropylene, polyimides, polyphenylenesulphides (PPS) and polypropylene (PP).

The thickness of the flat structure in accordance with step B) is preferably between 10 and 1000 μm, preferably between 15 and 500 μm, in particular between 20 and 300 μm and particularly preferably between 30 and 200 μm.

The polymerisation of the monomers in step C) or step II) is preferably a free-radical polymerisation. The formation of radicals can take place thermally, photochemically, chemically and/or electrochemically.

For example, a starter solution containing at least one substance capable of forming radicals can be added to the composition after heating of the composition in accordance with step A). Furthermore a starter solution can be applied to the flat structure obtained in accordance with step B). This can be performed by means of measures known per se (e.g., spraying, immersing etc.) which are known from the prior art. During production of the membrane through swelling, a starter solution can be added to the liquid. This can also be applied to the flat structure after swelling.

The polymerisation can also take place by action of IR or NIR (IR=infrared, i.e. light having a wavelength of more than 700 nm; NIR=near-IR, i.e. light having a wavelength in the range of about 700 to 2000 nm and an energy in the range of about 0.6 to 1.75 eV), respectively.

The polymerisation can also take place by action of UV light having a wavelength of less than 400 nm. This polymerisation method is known per se and described, for example, in Hans Joerg Elias, Makromolekulare Chemie, 5th edition, volume 1, pp. 492-511; D. R. Arnold, N. C. Baird, J. R. Bolton, J. C. D. Brand, P. W. M Jacobs, P. de Mayo, W. R. Ware, Photochemistry—An Introduction, Academic Press, New York and M. K. Mishra, Radical Photopolymerization of Vinyl Monomers, J. Macromol. Sci.-Revs. Macromol. Chem. Phys. C22 (1982-1983) 409.

The polymerisation may also take place by exposure to β rays, γ rays and/or electron rays. According to a particular embodiment of the present invention, a membrane is irradiated with a radiation dose in the range from 1 to 300 kGy, preferably from 3 to 250 kGy and very particularly preferably from 20 to 200 kGy.

The polymerisation of the monomers comprising phosphonic acid groups in step C) is or step II) preferably takes place at temperatures of more than room temperature (20° C.) and less than 200° C., in particular at temperatures between 40° C. and 150° C., particularly preferably between 50° C. and 120° C. The polymerisation is preferably performed at normal pressure, but can also be carried out with action of pressure. The polymerisation leads to a solidification of the flat structure, wherein this solidification can be observed via measuring the microhardness. Preferably, the increase in hardness caused by the polymerisation is at least 20%, based on the hardness of the flat structure obtained in step B).

According to a particular embodiment of the present invention, the membranes exhibit a high mechanical stability. This variable results from the hardness of the membrane which is determined via microhardness measurement in accordance with DIN 50539. To this end, the membrane is successively loaded over 20 s with a Vickers diamond up to a force of 3 mN and the depth of indentation is determined. According to this, the hardness at room temperature is at least 0.01 N/mm², preferably at least 0.1 N/mm² and very particularly preferably at least 1 N/mm² however, this should not constitute a limitation. Subsequently, the force is kept constant at 3 mN over 5 s and the creep of the depth of penetration is calculated In preferred membranes, the creep C_{HU} 0.003/20/5 under these conditions is less than 20%, preferably less than 10% and very particularly preferably less than 5%. The modulus determined by microhardness measurement, YHU is at least 0.5 MPa, in particular at least 5 MPa and very particularly preferably at least 10 MPa; however, this should not constitute a limitation.

The hardness of the membrane relates to both a surface which does not have a catalyst layer and a face that has a catalyst layer.

Depending on the degree of polymerisation desired, the flat structure which is obtained after polymerisation is a self-supporting membrane. Preferably, the degree of polymerisation is at least 2, in particular at least 5, particularly preferably at least 30, repeating units, in particular at least 50 repeating units, very particularly preferably at least 100 repeating units. This degree of polymerisation is determined via the number-average molecular weight Mₙ, which can be determined by means of GPC methods. Due to the problems of isolating the polymers comprising phosphonic acid groups and/or sulphonic acid groups contained in the membrane without degradation, this value is determined by means of a sample which is obtained by polymerisation of monomers comprising phosphonic acid groups and/or monomers comprising sulphonic acid groups without addition of polymer. In this connection, the weight proportion of monomers comprising phosphonic acid groups and/or sulphonic acid groups and of radical starters in comparison to the ratios of the production of the membrane is kept constant. The conversion obtained with a comparative polymerisation is preferably greater than or equal to 20%, in particular greater than or equal to 40% and particularly preferably greater than or equal to 75%, based on the monomers comprising phosphonic acid groups and/or monomers comprising sulphonic acid groups employed.

The polymers comprising phosphonic acid groups and/or sulphonic acid groups contained in the membrane preferably have a wide molecular weight distribution. Thus, the polymers comprising phosphonic acid groups can have a polydispersity M_{w}/Mₙ in the range from 1 to 20, particularly preferably from 3 to 10.

The water content of the proton-conducting membrane is preferably not more than 15% by weight, particularly preferably not more than 10% by weight and very particularly preferably not more than 5% by weight at an operating temperature of at least 90° C.

In this connection, it can be assumed that the conductivity of the membrane at operating temperatures of more than 100° C. may be based on the Grotthus mechanism whereby the system does not require any additional humidification. Preferred membranes accordingly comprise proportions of low molecular weight polymers comprising phosphonic acid groups and/or sulphonic acid groups. Thus, the proportion of polymers comprising phosphonic acid groups with a degree of polymerisation in the range from 2 to 20 can preferably be at least 10% by weight, particularly preferably at least 20% by weight, based on the weight of the polymers comprising phosphonic acid groups.

Preferably, the membrane obtained in accordance with step C) or step II) is self-supporting, i.e. it can be detached from the support without any damage and then directly processed further, if applicable.

The polymerisation in step C) or step II) can lead to a reduction in layer thickness.

Preferably, the thickness of the self-supporting membrane is between 8 and 990 μm, preferably between 15 and 500 μm, in particular between 25 and 175 μm.

Furthermore, the membrane may be thermally, photochemically, chemically and/or electrochemically cross-linked at the surface. This hardening of the membrane surface further improves the properties of the membrane.

According to a particular aspect, the membrane can be heated to a temperature of at least 150° C., preferably at least 200° C. and particularly preferably at least 250° C. Preferably, the thermal cross-linking takes place in the presence of oxygen. In this process step, the oxygen concentration usually is in the range of 5 to 50% by volume, preferably 10 to 40% by volume; however, this should not constitute a limitation.

The cross-linking can also take place by action of IR or NIR (IR=infrared, i.e. light having a wavelength of more than 700 nm; NIR=near-IR, i.e. light having a wavelength in the range of from about 700 to 2000 nm and an energy in the range of from about 0.6 to 1.75 eV), respectively, and/or UV light. Another method is exposure to β rays, γ rays and/or electron rays. In this connection, the radiation dose is preferably between 5 and 250 kGy, in particular 10 to 200 kGy. The irradiation can take place in the open air or under inert gas. Through this, the usage properties of the membrane, in particular its durability, are improved.

Depending on the desired degree of crosslinking, the duration of the crosslinking reaction may lie within a wide range. Generally, this reaction time is in the range from 1 second to 10 hours, preferably 1 minute to 1 hour; however, this should not constitute a limitation.

According to a particular embodiment of the present invention, the membrane comprises, according to an elemental analysis, at least 3% by weight, preferably at least 5% by weight and particularly preferably at least 7% by weight, of phosphorus, based on the total weight of the membrane. The proportion of phosphorus can be determined by elemental analysis. To this end, the membrane is dried at 110° C. for 3 hours under vacuum (1 mbar).

The polymers comprising phosphonic acid groups and/or sulphonic acid groups preferably have a content of phosphonic acid groups and/or sulphonic acid groups of at least 5 meq/g, particularly preferably at least 10 meq/g. This value is determined by way of the so-called ion exchange capacity (IEC).

To measure the IEC, the phosphonic acid and/or sulphonic acid groups are converted to the free acid, the measurement being performed before polymerisation of the monomers comprising phosphonic acid groups. Subsequently, the sample is titrated with 0.1 M NaOH. The ion exchange capacity (IEC) is then calculated from the consumption of acid up to the equivalent point and the dry weight.

The polymer membrane according to the invention has improved material properties compared to the doped polymer membranes previously known. In particular, they exhibit better performances in comparison with known doped polymer membranes. The reason for this is in particular an improved proton conductivity. This is at least 1 mS/cm, preferably at least 2 mS/cm, in particular at least 5 mS/cm and very particularly preferably at least 10 mS/cm at temperatures of 120° C., preferably 140° C.

Furthermore, the membranes also exhibit a higher conductivity at a temperature of 70° C. The conductivity depends, amongst other things, on the content of sulphonic acid groups of the membrane. The higher this proportion, the better is the conductivity at low temperatures. In this connection, a membrane according to the invention can be humidified at low temperatures. To this end, the compound used as energy source, for example hydrogen, may be provided with a proportion of water. In many cases, however, the water formed by the reaction is sufficient to achieve a humidification.

The specific conductivity is measured by means of impedance spectroscopy in a 4-pole arrangement in potentiostatic mode and using platinum electrodes (wire, 0.25 mm diameter). The distance between the current-collecting electrodes is 2 cm. The spectrum obtained is evaluated using a simple model consisting of a parallel arrangement of an ohmic resistance and a capacitor. The cross section of the sample of the membrane doped with phosphoric acid is measured immediately prior to mounting of the sample. To measure the temperature dependency, the measurement cell is brought to the desired temperature in an oven and regulated using a Pt-100 thermocouple arranged in the immediate vicinity of the sample. Once the temperature is reached, the sample is held at this temperature for 10 minutes prior to the start of measurement.

The crossover current density during operation with 0.5 M methanol solution and at 90° C. in a so-called liquid direct methanol fuel cell is preferably less than 100 mA/cm², in particular less than 70 mA/cm², particularly preferably less than 50 mA/cm² and very particularly preferably less than 10 mA/cm². The crossover current density during operation with a 2 M methanol solution and at 160° C. in a so-called gaseous direct methanol fuel cell is preferably less than 100 mA/cm², in particular less than 50 mA/cm², very particularly preferably less than 10 mA/cm².

In order to determine the crossover current density, the amount of carbon dioxide released at the cathode is measured by means of a CO₂ sensor. The crossover current density is calculated from the value obtained in this way for the amount of CO₂, as described by P. Zelenay, S. C. Thomas, S. Gottesfeld in S. Gottesfeld, T. F. Fuller “Proton Conducting Membrane Fuel Cells II” ECS Proc., vol. 98-27, pages 300-308.

According to a particular aspect of the present invention, a polymer membrane according to the invention can include one or two catalyst layers which are electrochemically active. The term “electrochemically active” means that the catalyst layer or layers are capable to catalyse the oxidation of fuels, for example H₂, methanol, ethanol, and the reduction of O₂.

The catalyst layer or catalyst layers contain catalytically active substances. These include, amongst others, precious metals of the platinum group, i.e. Pt, Pd, Ir, Rh, Os, Ru, or also the precious metals Au and Ag. Furthermore, alloys of the above-mentioned metals may also be used. Additionally, at least one catalyst layer can contain alloys of the elements of the platinum group with non-precious metals, such as for example Fe, Co, Ni, Cr, Mn, Zr, Ti, Ga, V, etc. Furthermore, the oxides of the above-mentioned precious metals and/or non-precious metals can also be employed. The catalytically active particles comprising the above-mentioned substances may be used as metal powder, so-called black precious metal, in particular platinum and/or platinum alloys. Such particles generally have a size in the range of 5 nm to 200 nm, preferably in the range of 7 nm to 100 nm.

Furthermore, the metals can also be used on a support material. Preferably, this support comprises carbon which particularly may be used in the form of carbon black, graphite or graphitised carbon black. Furthermore, electrically conductive metal oxides, such as for example, SnOₓ, TiOₓ, or phosphates, such as e.g. FePOₓ, NbPOₓ, Zr_{y}(POₓ)_{z}, can be used as support material. In this connection, the indices x, y and z designate the oxygen or metal content of the individual compounds which can lie within a known range as the transition metals can be in different oxidation stages.

The content of these metal particles on a support, based on the total weight of the bond of metal and support, is generally in the range of 1 to 80% by weight, preferably 5 to 60% by weight and particularly preferably 10 to 50% by weight; however, this should not constitute a limitation. The particle size of the support, in particular the size of the carbon particles, is preferably in the range from 20 to 100 nm, in particular 30 to 60 nm. The size of the metal particles present thereon is preferably in the range of 1 to 20 nm, in particular 1 to 10 nm and particularly preferably 2 to 6 nm.

The sizes of the different particles represent mean values and can be determined via transmission electron microscopy or X-ray powder diffractometry.

The catalytically active particles set forth above can generally be obtained commercially.

Furthermore, this catalyst layer can comprise ionomers comprising phosphonic acid groups and/or sulphonic acid groups which can be obtained by polymerisation of monomers comprising phosphonic acid groups and/or monomers comprising sulphonic acid groups.

The monomers comprising phosphonic acid groups were set forth above, so that reference is made thereto. Ethenephosphonic acid, propenephosphonic acid, butenephosphonic acid; acrylic acid and/or methacrylic acid compounds which include phosphonic acid groups, such as for example 2-phosphonomethylacryic acid, 2-phosphonomethyl methacrylic acid, 2-phosphonomethylacrylamide and 2-phosphonomethylmethacrylamide are preferably used for the preparation of the ionomers to be employed according to the invention.

Commercially available vinylphosphonic acid (ethenephosphonic acid), such as it is available from the companies Aldrich or Clariant GmbH, for example, is particularly preferably used. A preferred vinylphosphonic acid has a purity of more than 70%, in particular 90% and particularly preferably a purity of more than 97%.

Furthermore, monomers comprising sulphonic acid groups can be employed for the preparation of the ionomers.

According to a particular aspect of the present invention, mixtures of monomers comprising phosphonic acid groups and monomers comprising sulphonic acid groups are employed in the preparation of the ionomers, in which the weight ratio of monomers comprising phosphonic acid groups to monomers comprising sulphonic acid groups is in the range from 100:1 to 1:100, preferably 10:1 to 1:10 and particularly preferably 2:1 to 1:2. Furthermore, the ionomer can include units which are derived from the hydrophobic monomers mentioned above.

Furthermore, the ionomers can include repeating units which are derived from the hydrophobic monomers mentioned above.

The ionomer preferably has a molecular weight in the range from 300 to 100,000 g/mol, preferably from 500 to 50,000 g/mol. This value can be determined by means of GPC.

According to a particular aspect of the present invention, the ionomer can have a polydispersity M_{w}/Mₙ in the range from 1 to 20, particularly preferably from 3 to 10.

Furthermore, commercially available polyvinylphosphonic acids can also be employed as the ionomer. These are available from Polysciences Inc., amongst others.

According to a particular embodiment of the present invention, the ionomers can have a particularly uniform distribution in the catalyst layer. This uniform distribution can be achieved in particular by bringing the ionomers into contact with the catalytically active substances before applying the catalyst layer to the polymer membrane.

The uniform distribution of the ionomer in the catalyst layer can be determined by means of EDX, for example. In this connection, the scattering within the catalyst layer is at most 10%, preferably 5% and particularly preferably 1%.

The content of ionomer in the catalyst layer is preferably in the range from 1 to 60% by weight, particularly preferably in the range from 10 to 50% by weight.

According to elemental analysis, the proportion of phosphorus in the catalyst layer is preferably at least 0.3% by weight, in particular at least 3 and particularly preferably at least 7% by weight. According to a particular aspect of the present invention, the proportion of phosphorus in the catalyst layer is in the range from 3% by weight to 15% by weight.

To apply at least one catalyst layer, several methods can be employed. For example, a support can be used in step C) which is provided with a coating containing a catalyst to provide the layer formed in step C) with a catalyst layer.

In this connection, the membrane can be provided with a catalyst layer on one side or both sides. If the membrane is provided with a catalyst layer only on one side, the opposite side of the membrane has to be pressed together with an electrode which comprises a catalyst layer. If both sides of the membrane are to be provided with a catalyst layer, the following methods can also be applied in combination to achieve an optimal result.

According to the invention, the catalyst layer can be applied by a process in which a catalyst suspension is employed. Additionally, powders which comprise the catalyst can be used.

In addition to the catalytically active substance and the ionomers comprising phosphonic acid groups, the catalyst suspension can contain customary additives. These include, amongst others, fluoropolymers, such as e.g. polytetrafluoroethylene (PTFE), thickeners, in particular water-soluble polymers, such as e.g. cellulose derivatives, polyvinyl alcohol, polyethylene glycol, and surface-active substances.

The surface-active substances include in particular ionic surfactants, for example salts of fatty acids, in particular sodium laurate, potassium oleate; and alkylsulphonic acids, salts of alkylsulphonic acids, in particular sodium perfluorohexanesulphonate, lithium perfluorohexanesulphonate, ammonium perfluorohexanesulphonate, perfluorohexanesulphonic acid, potassium nonafluorobutanesulphonate, as well as non-ionic surfactants, in particular ethoxylated fatty alcohols and polyethylene glycols.

Furthermore, the catalyst suspension can comprise components that are liquid at room temperature. These include, amongst others, organic solvents which can be polar or non-polar, phosphoric acid, polyphosphoric acid and/or water. The catalyst suspension preferably contains 1 to 99% by weight, in particular 10 to 80% by weight, of liquid components.

The polar organic solvents include in particular alcohols, such as ethanol, propanol, isopropanol and/or butanol.

The organic, non-polar solvents include, amongst others, known thinning agents for thin layers, such as the thinning agent for thin layers 8470 from the company DuPont which comprises oils of turpentine.

Fluoropolymers, in particular tetrafluoroethylene polymers, represent particularly preferred additives. According to a particular embodiment of the present invention, the catalyst suspension can contain 0 to 60% of fluoropolymer, based on the weight of the catalyst material, preferably 1 to 50%.

In this connection, the weight ratio of fluoropolymer to catalyst material comprising at least one precious metal and optionally one or more support materials can be greater than 0.1, this ratio preferably lying within the range from 0.2 to 0.6.

The catalyst suspension can be applied to the membrane by customary processes. Depending on the viscosity of the suspension which can also be in the form of a paste, several methods are known by which the suspension can be applied. Processes for coating films, fabrics, textiles and/or paper, in particular spraying methods and printing processes, such as for example screen and silk screen printing processes, inkjet printing processes, application with rollers, in particular anilox rollers, application with a slit nozzle and application with a doctor blade, are suitable. The corresponding process and the viscosity of the catalyst suspension depend on the hardness of the membrane.

The viscosity can be controlled via the solids content, especially the proportion of catalytically active particles, and the proportion of additives. The viscosity to be adjusted depends on the method of application of the catalyst suspension, the optimal values and the determination thereof being familiar to the person skilled in the art.

Depending on the hardness of the membrane, an improvement of the bond of catalyst and membrane can be effected by heating and/or pressing. Furthermore, the bond between membrane and catalyst is increased by a surface cross-linking treatment described above which can take place thermally, photochemically, chemically and/or electrochemically.

According to a particular aspect of the present invention, the catalyst layer is applied by a powder process. In this connection, a catalyst powder is used which can contain additional additives which were exemplified above.

To apply the catalyst powder, spraying processes and screening processes, amongst others, can be employed. In the spraying process, the powder mixture is sprayed onto the membrane via a nozzle, for example a slit nozzle. Generally, the membrane provided with a catalyst layer is subsequently heated to improve the bond between catalyst and membrane. The heating process can be performed via a hot roller, for example. Such methods and devices for applying the powder are described in DE 195 09 748, DE 195 09 749 and DE 197 57 492, amongst others.

In the screening process, the catalyst powder is applied to the membrane by a vibrating screen. A device for applying a catalyst powder to a membrane is described in WO 00/26982. After applying the catalyst powder, the bond of catalyst and membrane can be improved by heating. In this connection, the membrane provided with at least one catalyst layer can be heated to a temperature in the range from 50 to 200° C., in particular 100 to 180° C.

Furthermore, the catalyst layer can be applied by a process in which a coating containing a catalyst is applied to a support and the coating containing a catalyst and present on the support is subsequently transferred to a membrane. As an example, such a process is described in WO 92/15121.

The support provided with a catalyst coating can be produced, for example, by preparing a catalyst suspension described above. This catalyst suspension is then applied to a backing film, for example made of polytetrafluoroethylene. After applying the suspension, the volatile components are removed.

The transfer of the coating containing a catalyst can be performed by hot pressing, amongst others. To this end, the composite comprising a catalyst layer and a membrane as well as a backing film is heated to a temperature in the range from 50° C. to 200° C. and pressed together with a pressure of 0.1 to 5 MPa. In general, a few seconds are sufficient to join the catalyst layer to the membrane. Preferably, this period of time is in the range from 1 second to 5 minutes, in particular 5 seconds to 1 minute.

According to a particular embodiment of the present invention, the catalyst layer has a thickness in the range from 1 to 1000 μm, in particular from 5 to 500, preferably from 10 to 300 μm. This value represents a mean value, which can be determined by averaging the measurements of the layer thickness from photographs that can be obtained with a scanning electron microscope (SEM).

According to a particular embodiment of the present invention, the membrane provided with at least one catalyst layer comprises 0.1 to 10.0 mg/cm², preferably 0.2 to 6.0 mg/cm² and particularly preferably 0.2 to 2 mg/cm² of the catalytically active metal, e.g. Pt. These values can be determined by elemental analysis of a flat sample. If the membrane should be provided with two opposing catalyst layers, the values of the weight per unit area of the metal per catalyst layer mentioned above apply.

According to a particular aspect of the present invention, one side of a membrane exhibits a higher metal content than the opposite side of the membrane. Preference is given to the metal content of the one side being at least twice as high as the metal content of the opposite side.

Following the treatment in accordance with step C) or after applying the catalyst layer, the membrane can further be cross-linked by action of heat in the presence of oxygen. This curing of the membrane additionally improves the properties of the membrane. To this end, the membrane can be heated to a temperature of at least 150° C., preferably at least 200° C. and particularly preferably at least 250° C. In this process step, the oxygen concentration usually is in the range of 5 to 50% by volume, preferably 10 to 40% by volume; however, this should not constitute a limitation.

The cross-linking can also take place by action of IR or NIR (IR=infrared, i.e. light having a wavelength of more than 700 nm; NIR=near-IR, i.e. light having a wavelength in the range of about 700 to 2000 nm and an energy in the range of about 0.6 to 1.75 eV), respectively. Another method is β-ray irradiation. In this connection, the irradiation dose is between 5 and 200 kGy.

Depending on the desired degree of crosslinking, the duration of the crosslinking reaction may lie within a wide range. Generally, this reaction time is in the range from 1 second to 10 hours, preferably 1 minute to 1 hour; however, this should not to constitute a limitation.

Possible fields of use for the polymer membranes according to the invention include, amongst others, the use in fuel cells, electrolysis, capacitors and battery systems.

The present invention also relates to a membrane electrode assembly which includes at least one polymer membrane according to the invention. For further information on membrane electrode assemblies, reference is made to the technical literature, in particular the U.S. Pat. No. 4,191,618, U.S. Pat. No. 4,212,714 and U.S. Pat. No. 4,333,805. The disclosure contained in the above-mentioned citations [U.S. Pat. No. 4,191,618, U.S. Pat. No. 4,212,714 and U.S. Pat. No. 4,333,805] with respect to the structure and production of membrane electrode assemblies as well as the electrodes, gas diffusion layers and catalysts to be chosen is also part of the description.

To produce a membrane electrode assembly, the membrane according to the invention can be bonded with a gas diffusion layer. If both sides of the membrane are provided with a catalyst layer, the gas diffusion layer should not include a catalyst before compression. However, gas diffusion layers provided with a catalytically active layer can also be employed. The gas diffusion layer in general exhibits electron conductivity. Flat, electrically conductive and acid-resistant structures are commonly used for this. These include, for example, carbon-fibre paper, graphitised carbon-fibre paper, carbon-fibre fabric, graphitised carbon-fibre fabric and/or flat structures which were rendered conductive by addition of carbon black.

The bonding of the gas diffusion layers with the membrane provided with at least one catalyst layer is effected by compressing the individual components under the usual conditions. In general, lamination is carried out at a temperature in the range of 10 to 300° C., in particular 20° C. to 200° C. and with a pressure in the range of 1 to 1000 bar, in particular 3 to 300 bar.

Furthermore, the bonding of the membrane with the catalyst layer can also be effected by employing a gas diffusion layer provided with a catalyst layer. In this connection, a membrane electrode assembly can be formed from a membrane without catalyst layer and two gas diffusion layers provided with a catalyst layer.

A membrane electrode assembly according to the invention exhibits a surprisingly high power density. According to a particular embodiment, preferred membrane electrode assemblies accomplish a current density of at least 0.05 A/cm², preferably 0.1 A/cm², particularly preferably 0.2 A/cm². This current density is measured in operation with pure hydrogen at the anode and air (approx. 20% by volume of oxygen, approx. 80% by volume of nitrogen) at the cathode, with standard pressure (1013 mbar absolute, with an open cell outlet) and a cell voltage of 0.6 V. in this connection, particularly high temperatures in the range of 150-200° C., preferably 160-180° C., in particular 170° C. can be applied. Furthermore, the MEA according to the invention can also be operated in a temperature range lower than 100° C., preferably from 50-90° C., in particular at 80° C. At these temperatures, the MEA exhibits a current density of at least 0.02 A/cm², preferably of at least 0.03 A/cm² and particularly preferably of 0.05 A/cm², measured at a voltage of 0.6 V under the conditions otherwise mentioned above.

The power densities mentioned above can also be achieved with a low stoichiometry of the fuel gas. According to a particular aspect of the present invention, the stoichiometry is lower than or equal to 2, preferably lower than or equal to 1.5, very particularly preferably lower than or equal to 1.2. The oxygen stoichiometry is lower than or equal to 3, preferably lower than or equal to 2.5 and particularly preferably lower than or equal to 2.

1-18. (canceled)

19. A membrane for fuel cells comprising a polymer comprising phosphonic acid and/or sulphonic acid groups, wherein said polymer comprising phosphonic acid and/or sulphonic acid groups is obtained by copolymerization of at least one monomer comprising phosphonic acid and/or sulphonic acid groups and hydrophobic monomers.

20. The membrane of claim 19, wherein the water solubility of said polymer comprising phosphonic acid and/or sulphonic acid groups is not greater than 10 g/L.

21. The membrane of claim 19, wherein the weight ratio of said monomers comprising phosphonic acid and/or sulphonic acid groups to said hydrophobic monomers is in the range of from 10:1 to 1:10.

22. The membrane of claim 19, wherein said polymer comprising phosphonic acid and/or sulphonic acid groups is a random copolymer, a block copolymer, or a graft copolymer.

23. The membrane of claim 19, wherein said membrane contains at least 50% by weight of a polymer comprising phosphonic acid and/or sulphonic acid groups.

24. The membrane of claim 19, wherein said at least one monomer comprising phosphonic acid and/or sulphonic acid groups is of the formula 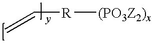
wherein
R is a bond, a divalent C1-C15 alkylene group, a divalent C1-C15 alkyleneoxy group, or a divalent C5-C20 aryl or heteroaryl group, optionally substituted with halogen, —OH, COOZ, —CN, and/or NZ₂;
Z is, independent of one another, H, a C1-C15 alkyl group, a C₁-C₁₅ alkoxy group, an ethyleneoxy group, or a C5-C20 aryl or heteroaryl group, optionally substituted with halogen, —OH, and/or —CN;
x is an integer selected from the group consisting of 1, 2, 3, 4, 5, 6, 7, 8, 9, or 10; and
y is an integer selected from the group consisting of 1, 2, 3, 4, 5, 6, 7, 8, 9, or 10;
and/or of the formula 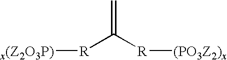
wherein
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, an ethyleneoxy group, or a C₅-C₂₀ aryl or heteroaryl group, optionally substituted with halogen, —OH, and/or —CN; and
x is an integer selected from the group consisting of 1, 2, 3, 4, 5, 6, 7, 8, 9 or 10;
and/or of the formula 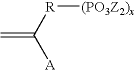
wherein
A is a group having the formula COOR², CN, CONR²₂, OR², or R², wherein R² is H, a C₁-C₁₅ alkyl group, a C₁-C₁₅ alkoxy group, an ethylenoxy group, or a C₅-C₂₀ aryl or heteroaryl group, optionally substituted by halogen, —OH, COOZ, —CN, and/or NZ₂;
R is a bond, a divalent C1-C15 alkylene group, a divalent C1-C15 alkyleneoxy group, or a divalent C5-C20 aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, an ethyleneoxy group or a C₅-C₂₀ aryl or heteroaryl group, optionally substituted with halogen, —OH, and/or —CN; and
x is an integer selected from the group consisting of 1, 2, 3, 4, 5, 6, 7, 8, 9 or 10.

25. The membrane of claim 19, wherein said at least one monomer comprising phosphonic acid and/or sulphonic acid groups is of the formula 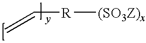
wherein
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₂₀ alkyl group, a C₁-C₁₅ alkoxy group, an ethyleneoxy group, or a C₅-C₂₀ aryl or heteroaryl, optionally substituted with halogen, —OH, and/or —CN;
x is an integer selected from the group consisting of 1, 2, 3, 4, 5, 6, 7, 8, 9 or 10; and
y is an integer selected from the group consisting of 1, 2, 3, 4, 5, 6, 7, 8, 9 or 10;
and/or of the formula 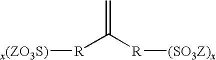
wherein
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, an ethyleneoxy group, or a C₅-C₂₀ aryl or heteroaryl group, optionally substituted with halogen, —OH, and/or —CN; and
x is an integer selected from the group consisting of 1, 2, 3, 4, 5, 6, 7, 8, 9 or 10;
and/or of the formula 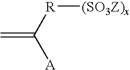
wherein
A is a group having the formula COOR², CN, CONR²₂, OR², or R², wherein R² is H, a C₁-C₁₅ alkyl group, a C₁-C₁₅ alkoxy group, an ethylenoxy group, or a C₅-C₂₀ aryl or heteroaryl group, optionally substituted by halogen, —OH, COOZ, —CN, and/or NZ₂;
R is a bond, a divalent C₁-C₁₅ alkylene group, a divalent C₁-C₁₅ alkyleneoxy group, or a divalent C₅-C₂₀ aryl or heteroaryl group, optionally substituted with halogen, —OH, COOZ, —CN, and/or NZ₂;
Z is, independent of one another, H, a C₁-C₁₅ alkyl group, a C₁-C₁₅ alkoxy group, an ethyleneoxy group, or a C₅-C₂₀ aryl or heteroaryl group, optionally substituted with halogen, —OH, and/or —CN; and
x is an integer selected from the group consisting of 1, 2, 3, 4, 5, 6, 7, 8, 9 or 10.

26. The membrane of claim 19, wherein said hydrophobic monomer is selected from the group consisting of 1-alkenes, branched alkenes, acetylene monomers, vinyl halides, acrylic monomers, vinyl ether monomers, vinyl esters, vinyl sulphide; methyl Isopropenyl ketone; 1,2-epoxypropene, styrene monomers, heterocyclic vinyl compounds, vinyl and isoprenyl ethers, maleic acid monomers, fumaric acid monomers, (meth)acrylates, and mixtures thereof.

27. The membrane of claim 26, wherein said
1-alkenes are selected from the group consisting of ethylene, 1,1-diphenylethylene, propene, 2-methylpropene, 1-butene, 2,3-dimethyl-1-butene, 3,3-dimethyl-1-butene, 2-methyl-1-butene, 3-methyl-1-butene, 2-butene, 2,3-dimethyl-2-butene, hexene-1, and heptene-1;
branched alkenes are selected from the group consisting of vinylcyclohexane, 3,3-dimethyl-1-propene, 3-methyl-1-diisobutylene, and 4-methylpentene-1;
acetylene monomers are selected from the group consisting of acetylene, diphenylacetylene, and phenylacetylene;
vinyl halides are selected from the group consisting of vinyl fluoride, vinyl iodide, 1-chloroethylene, 11-dichloroethylene, 1,2-dichloroethylene, trichloroethylene, tetrachloroethylene, tribromoethylene, 2-dibromoethylene, tetrabromoethylene, tetrafluoroethylene, tetraiodoethylene, 1-chloropropene, 2-chloropropene, 1,1-dichloropropene, 1,2-dichloropropene, 1,1,2-trichloropropene, 1,2,3-trichloropropene, 3,3,3-trichloropropene, 1-bromopropene, 2-bromopropene, and 4-bromo-1-butene;
acrylic monomers are selected from the group consisting of acrolein, 1-chloroacrolein, 2-methylacrylamide, and acrylonitrile;
vinyl ether monomers are selected from the group consisting of vinyl butyl ether, vinyl ether, vinyl fluoride, vinyl iodide, vinyl isoamyl ether, vinyl phenyl ether, vinyl ethyl ether, vinyl isobutyl ether, vinyl isopropyl ether, and vinyl ethyl ether;
vinyl ester is vinyl acetate;
styrene monomers are selected from the group consisting of styrene, α-methylstyrene, α-ethylstyrene, 1-methylstyrene, vinyl toluene, p-methylstyrene, 1-chlorostyrene, 2-chlorostyrene, m-chlorostyrene, p-chlorostyrene, dichlorostyrenes, 2-bromostyrene, p-bromostyrene, tribromostyrenes, tetrabromostyrenes, m-fluorostyrene, o-fluorostyrene, m-methoxystyrene, o-methoxystyrene, p-methoxystyrene, and 2-nitrostyrene;
heterocyclic vinyl compounds are selected from the group consisting of 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles, hydrogenated vinylthiazoles, vinyloxazoles, and hydrogenated vinyloxazoles;
maleic acid monomers are selected from the group consisting of maleic acid, dihydroxymaleic acid, maleic anhydride, methylmaleic anhydride, dimethyl maleate, diethyl maleate, diphenyl maleate, maleimide, and methylmaleimide; and
fumaric acid monomers are selected from the group consisting of fumaric acid;
dimethylfumaric acid, diisobutyl fumarate, dimethyl fumarate, diethyl fumarate, and diphenyl fumarate.

28. The membrane of claim 19, wherein said membrane comprises at least one polymer (B) which differs from the polymer comprising phosphonic acid groups.

29. The membrane of claim 19, wherein said polymers comprising phosphonic acid groups and/or sulphonic acid groups are cross-linked thermally, photochemically, chemically, and/or electrochemically.

30. The membrane of claim 28, wherein said polymers comprising phosphonic acid groups and/or sulphonic acid groups are crosslinked using cross-linking monomers.

31. The membrane of claim 19, wherein said membrane has a thickness in the range of from 15 to 1000 μm.

32. The membrane of claim 19, wherein said membrane has a conductivity of at least 1 mS, measured at 160° C. without humidification.

33. The membrane of claim 19, wherein said polymer comprising phosphonic acid groups and/or sulphonic acid groups has a weight average molecular weight of at least 3000 g/mol.

34. A process for preparing the membrane of claim 19, comprising:
A) preparing a composition comprising hydrophobic monomers and monomers comprising phosphonic acid groups and/or sulphonic acid groups;
B) applying a layer of the composition of step A) to a support to form a flat structure; and
C) polymerizing the monomers present in the flat structure of B).

35. A process for preparing the polymer membrane of claim 19, comprising:
I) swelling a polymer film with a liquid containing hydrophobic monomers and monomers comprising phosphonic acid groups and/or sulphonic acid groups; and
II) polymerizing at least part of the monomers of said polymer film of I).

36. A membrane electrode assembly comprising at least one membrane of claim 19.

37. A fuel cell comprising one or more membrane electrode assemblies of claim 36.
